(19) United States
(12) Patent Application Publication
(10) Pub. No.: US 2023/0252182 A1
(43) Pub. Date: Aug. 10, 2023

(54) System And Method For Recording User's On-Screen Activity Including The Confidentiality Of the Processed Data and Data Export To An External System

(71) Applicant: Adusso Oy, Helsinki (FI)

(72) Inventors: Janne Petteri PITKÄNEN, HELSINKI (FI); Matti Hermanni PITKÄRANTA, HYVINKÄÄ (FI); Antti Kalevi HAAPALA, OULU (FI)

(21) Appl. No.: 17/665,547

(22) Filed: Feb. 6, 2022

(51) Int. Cl. G06F 21/62

(52) U.S. Cl. CPC G06F 21/6245

(57) ABSTRACT

The present disclosure is directed to a system and method for a recording user's on-screen activity including the confidentiality of the processed data and ticketing system. It facilitates as-is screen recording along with further processing of recorded clips as ticket reporting based on recorded content wherein recorded content may be supervised by predefined confidentiality rules that defined the areas to be or erase or displayed to ensure no unauthorized access. It further enables permissions based on predefined confidentiality rules. Furthermore, the disclosure improves the storage of content on the first user processor that will be further displayed on the second user processor.

### BACKGROUND OF THE INVENTION

Recording video sessions to provide better customer service is one of the most often used ways of error detection when it comes to software user experience evaluation. At the same time, recording on-screen activity is only a first element to diagnose user experience issues and errors as for the recording to become fully functional, it needs to also give the user the possibility to report concrete issues with timestamps. Among others, screen recordings require several technical elements to be fully operational as for example smooth operation, low impact on system performance, and the ability to maintain privacy. Providing all three elements in one requires creating a jointly functioning service that re-uses the collected video content for multiple purposes, such as ticket reporting further enables to avoid repetitive recording while such action may be exchanged with one recording collection and further processing performed on the data already collected.

With regard to the processing of personal data, on-screen activity recording becomes quite sensitive when it comes to medical data. The confidentiality aspect of the medical data and related information becomes ever more important when reporting feedback or error concerns for a screen that is displaying or otherwise occupied with health care information. A proposed solution for maintaining user and/or information confidence and at the same time facilitates the confidential data processing in a manner that ensures a limited probability of unauthorized access.

At present, known solutions are not fully addressing the above-listed issues and, to the extent such solutions exist, are cumbersome, ineffective and tend to overload a user's computer system with processing and other such technical requirements as well as may require fully on-server processing with the exclusion of local database storage. The local recording capability of the invention is aimed at capturing user interaction objectively as seen by the user and for ensuring that the recording can be stored temporarily in cases of network connection interruptions that may cause user experience issues worth capturing from the user's point of view. Both local storage (on-site) and cloud-based storage may be used interchangeably.

### BRIEF SUMMARY OF THE INVENTION

The present disclosure is directed to screen recording and further processing of recorded display actions. In particular, the present disclosure makes use of as-is recording features and the possibility to process recorded views in an event-based manner that ultimately enables the user to report an error concerning displayed elements (for example dropdown). It further automates the process of session recording in a way that makes it faster for the second user of the invention to access the session regarding the reported error due to timestamped recording in the form of independent 50 seconds long clips.

To ensure the right background to diagnose the issue reported by the first user the system and method steps facilitate the export of data to external ticketing systems that enable ticket creation based on the recorded screen of the first user. Such ticket creation includes textual information or spoken comments made by the first user while reporting an error. Collected data is further assigned to the timestamped clips and transferred to the second user in the form of a report triggered by the first user.

The present disclosure provides further processing of recorded video clips including displaying only the information defined as non-confidential to enable processing of recorded clips by the second user while such clips include data that are or may be confidential and should otherwise not be shared by the first user with any other party.

The present disclosure is designed in a manner enabling optimal usage of processors assets and limits the usage of processing actions during recording and during storage. Consequently, the disclosure provides faster access to information to the disclosure users.

The present invention is directed to a system and method for recording user's on-screen activity including the confidentiality of the processed data and export to the external ticketing system wherein such export includes selected recorded data with collected timestamps.

### BRIEF DESCRIPTION OF THE SEVERAL VIEWS OF DRAWING

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the disclosure are set out with reference to the accompanying drawings, wherein:

FIG. 1 depicts a simplified connection scheme regarding communication between the first user processor and the second user processor;

FIG. 2 depicts how the recording module communicates with the first user processor and how it collects the data from displayed elements;

FIG. 3 depicts the recording of keystrokes from both virtual and non-virtual keyboards by the recording module;

FIG. 4 depicts the communication between distinguished components of the recording module with the first user processor with API and HTTPS use;

FIG. 5 depicts the flow of actions that happens between the first and the second processor during recording and potential export to the ticketing;

FIG. 6 depicts the allocation of the recording module jointly with the content interpretation module in connection with recording of sessions and the export to the ticketing system are being operational;

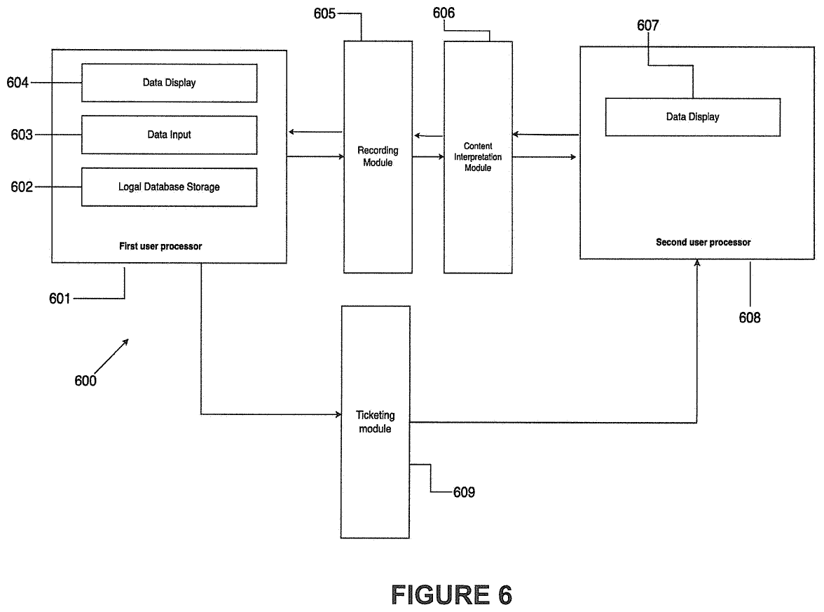

FIG. 7 depicts the simplified flow of interaction between the first user and second user processor with the export to the ticketing module;

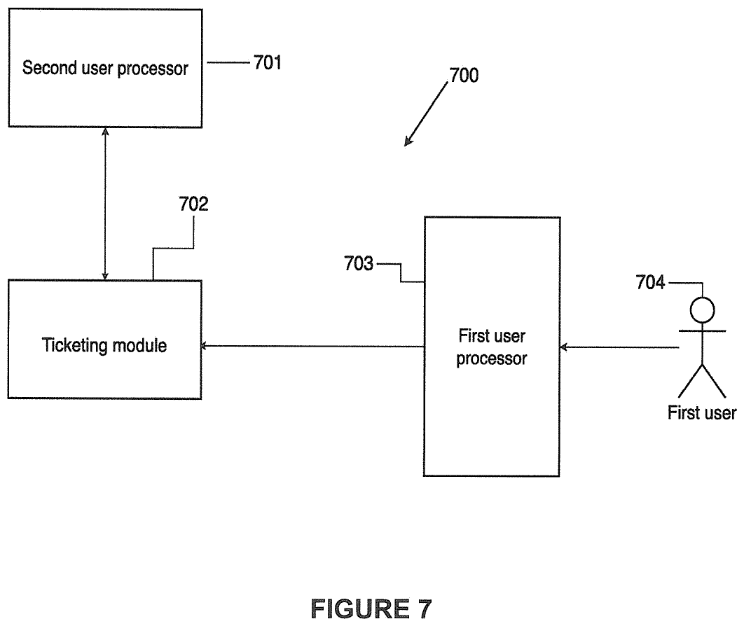

FIG. 8 depicts the allocation of the permission module in connection with recording of sessions and the export to the ticketing system are being operational;

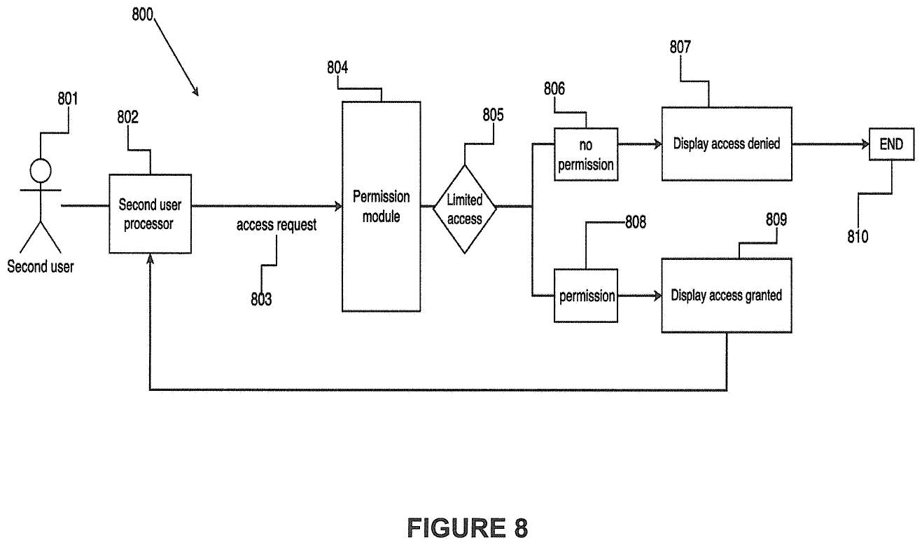

FIG. 9 depicts the connection scheme regarding communication between components of the first user processor, export to the ticketing system configured on the server, and second user display;

FIG. 10 depicts a simplified connection scheme regarding communication between the local storage database and cloud database;

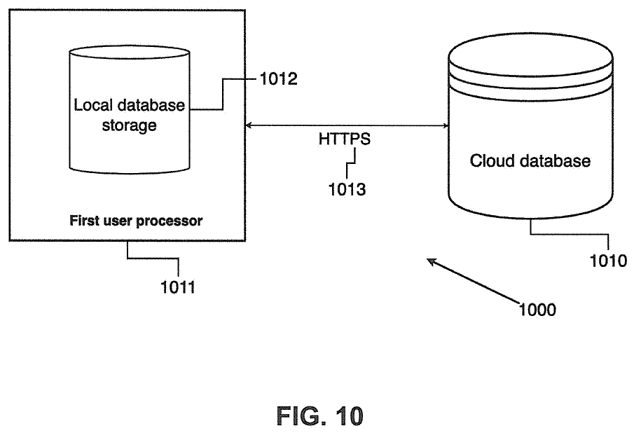

FIG. 11 depicts a simplified scheme of the flow of actions that are included during recording, export to the ticketing system, and displaying to the second user;

FIG. 12 depicts a screenshot from the recording of the screen with filtered content displayed without redrawn content being displayed;

FIG. 13 depicts an example of the OCR detected content to be redrawn or to remain filtered for the display of the second user; and

FIG. 14 depicts an example of filtered content displayed on the second user processor with whitelisted words redrawn on the processor's display.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

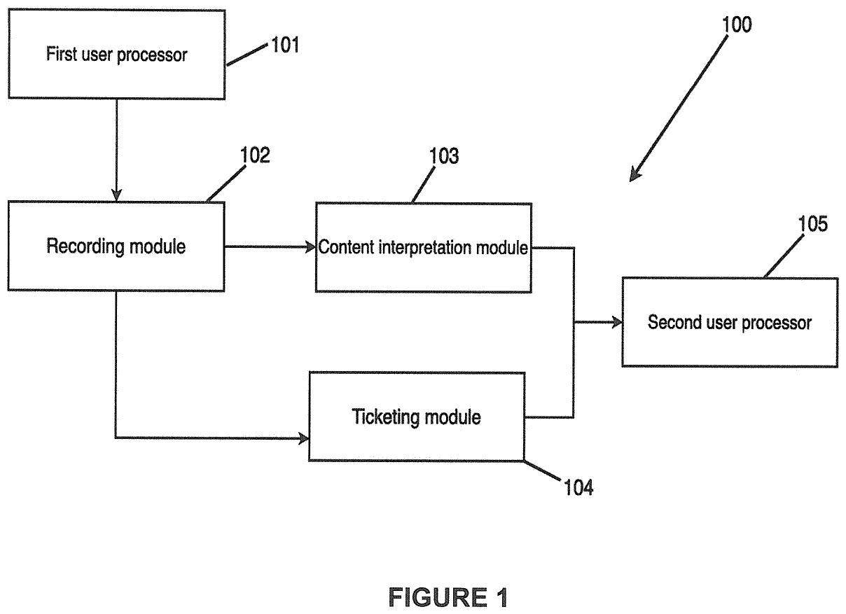

The present invention is generally directed to the problem of using information originating from the recording sessions. While many emergent problems are easy to detect by the users, they are difficult to trace back without a sufficient recording of the user's interaction with their respective computer systems and/or networks upon which such systems operate. As disclosed by FIG. 1, the present invention makes it possible to record user interaction as it happens or in real-time at a computer workstation or laptop (the first user processor) (101) and further register user interaction as displayed (102) and insight by event tagging along with real use and ticket reports (104) that are further enabled by the option to send the data to the external ticketing system. The present disclosure enables the data export to the ticketing system in a form that includes all recorded content and additional textual information in a format easily readable by third-party providers. It further interprets the content to be displayed in order to analyze its components (103) which further enables processing as for example ticketing (104). What is more, the present invention is dedicated to continuous user performance and interaction as is. Users can point out any issues of use just by pressing a button and the second user serving as support can view ticket reporting along with recorded clips for faster and more efficient issue diagnostics. Optional comments can be left either to writing or speaking which is received by the first user processor.

Additionally, the disclosed invention is a tool to record user interaction as is in an understandable foil at to be re-played by the second user (being for example a support team responsible for ticket solving) and software developers cooperating with the second user (being for example IT specialists of, for example, a hospital, collecting medical data regarding a patient)(105). The recording module (201) configured on the server (202), and a log of interaction events, such as keystrokes (209) and mouse clicks (208), are continuously recording (205) the display of the first user (206) during computer usage upon starting the recording on the first user processor. The process of making a video (203) including screen display recording, is triggered by the first user on the first user processor (204). The ticketing system (210) as enabled on the first user processor is operating on text files (207) and triggers dedicated clips recording that includes user reaction (211) from the display with keystrokes and on-screen clicks. Collected keystrokes include both virtual (308) and non-virtual (308) keyboard strokes.

The purpose of continuous user interaction recording in the background is to allow the first user to gather user experiences in actual context by marking up a moment of use with a positive, negative, or neutral timestamped tag, and a short written or spoken comment along with that jointly named ticket.

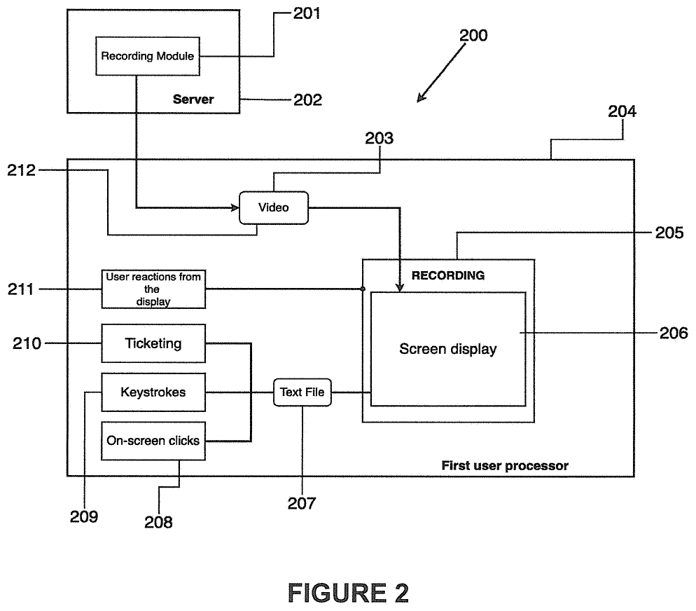

The system and method steps disclosed by FIG. 2 are directed towards recording the first user display with all elements visible on it, including mouse and clicking elements in clips, and facilitating further operations such as exporting to the ticketing system and defining areas to display and record.

The system starts on the first user processor that is configured to enable recording of the user's computer screen, keystrokes, and mouse clicks. The user can mark up any moment of interest with a dedicated button interface. Audio recording is optional, and keystrokes can be selectively masked out, such as for password confidentiality. The video recording is stored as a movie recording in MP4 or similar such format as short consecutive clips with pre-defined length (typical default is 30 to 50 sec.) Keystrokes, mouse clicks, and user markups are composed as a subtitle file for each video recording.

The video files along with the subtitle files are directly viewable with a compatible video player such as a VLC player. By way of example, the first user processor is operated by the first user, for example, a patient, who wishes to report an error that his or her medical record is not fully visible on the screen. In such a situation, the actions performed by the user (patient) on the screen are recorded by the recording module including as is displayed view. The present system is accessing the usage of end-user interface devices with a hook procedure for mouse and keyboard interfaces, and GDI Grab (or optional DirectShow) for physically or virtually connected displays. Compatible display interfaces include native resolution displays as well as display configurations when “Advanced scaling” is enabled on Windows 10 or similar environments. Display recording (303) is captured using ffmpeg (304) and the first and second users can replace this with a different version to enable modifications in this open-source software.

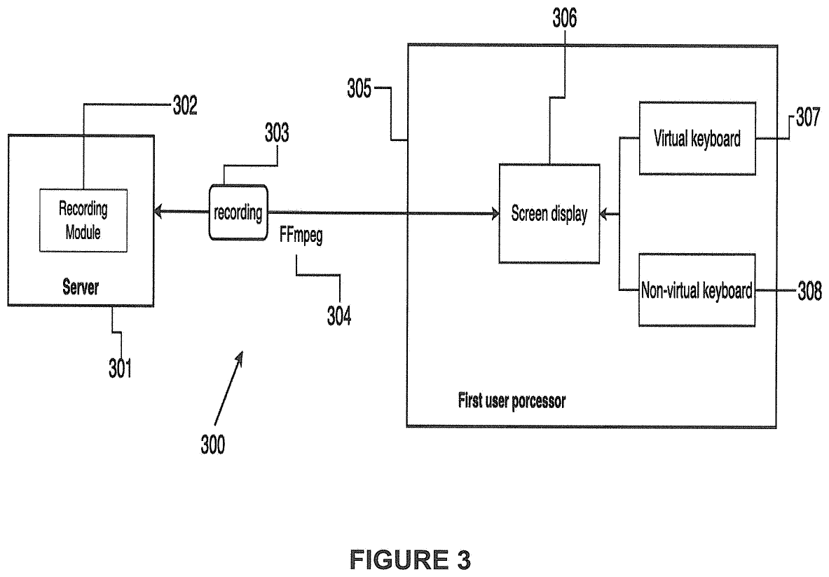

Keyboard and mouse events are captured virtually and non-intrusively by tapping into the user inputs of the keyboard and mouse on the first user's computer (the first user processor) as disclosed by FIG. 3. The invention is designed in such a way that it enables screen recording (306) and further actions on the recorded display (303) as ticket set up or limiting displayed information visible on the recording due to predefined security conditions.

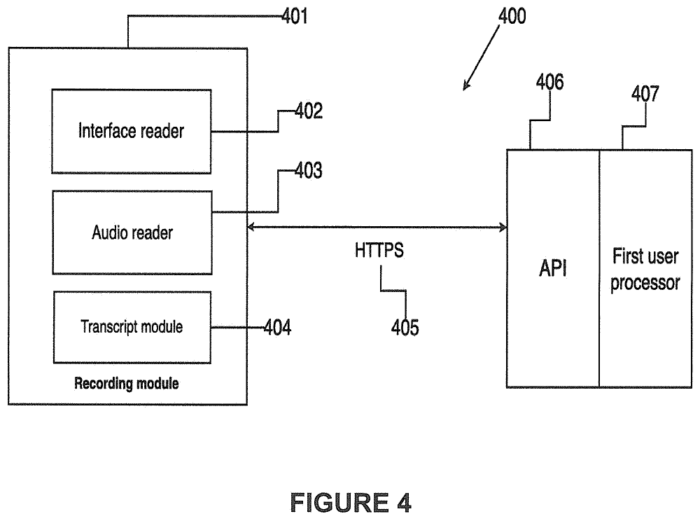

As disclosed in FIG. 4, the invention facilitates interface reader (402), transcript module (404), and voice recording by the audio reader (403) that is enabled in settings provided on the first user processor regulating the work of a microphone available at the user's computer. This microphone may be used for recording spoken comments and thinking aloud during user experience monitoring. No voice recording is applied without user consent and there is always an option to disconnect or switch off the microphone by the user. All three elements as disclosed above namely interface reader, transcript module, and audio reader, are configured on the recording module (401). It further communicates with the first user processor (407) via API (406) and HTTPS (405). Microphone of the first user processor may be further used for voice control to enter content on the computer.

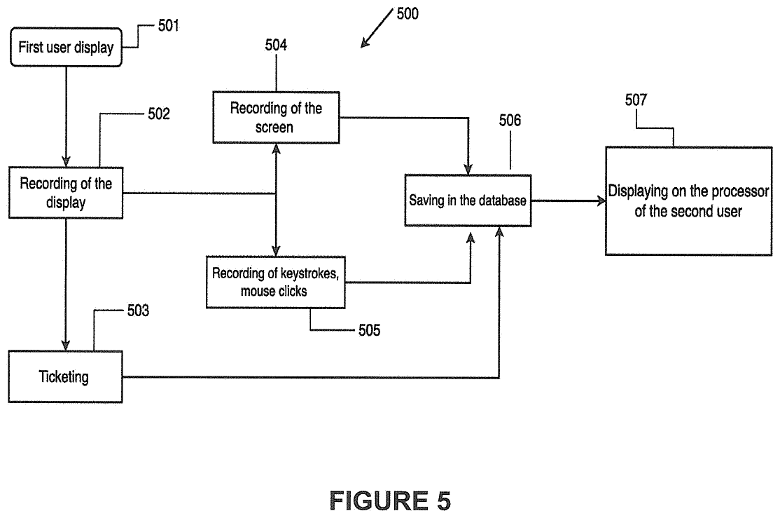

The simplified flow based on the recording of the first user processor, including the above-described elements of communication, is further disclosed in FIG. 5. The first user display (501) is further captured by the recording module responsible for the recording of the displayed content (502). Recorded content includes a collective recording of the displayed content (504) and event-based recording of the keystrokes, mouse clicks, and following interactive actions performed by the first user (505). This recorded content may be further processed to trigger the ticketing option on the first user processor (503). Both recorded content and tickets are saved in the database (506) that further transfers the information saved to display it to the second user (507). Upon individual set up the database may be either a local storage database or a cloud database.

Textual context detection of the content displayed on the process of the first user (601) provided by the content interpretation module operating on the server and analyzing the recorded user display is based on common words and phrases present in the first user display. The content interpretation module (606) is further configured to operate with the recording module (605) that provides recorded display including texts (604) and inputs (603) further saved in the local storage database (602). Such texts can be window titles, headers, and labels or items of user interface elements like button identifiers or drop-down menu items. In addition, web-based systems may contain information about user context information in URL (Uniform Resource Locator), e.g., an identifier of a view where the user is navigating in an information system as a part of the URL. These words and phrases are matched against OCR (Optical Character Recognition) information from recorded video frames. Selected information recorded on the first user processor is further transferred to the ticketing system (609) and displayed on the second user processor (608) via data display (607). As a consequence, the first user (704) is directly enabled via the first user processor (703) to report the issue to the second user (701) (support team) via the ticketing module (702).

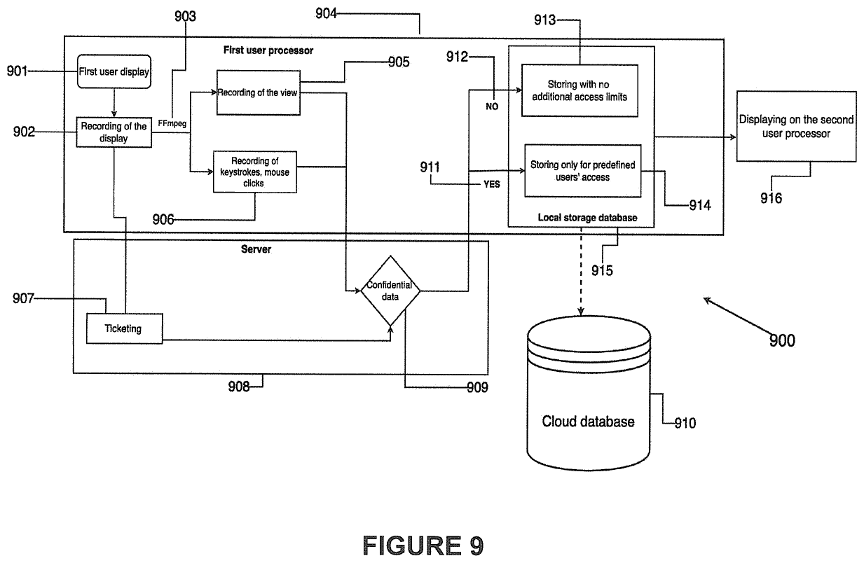

During the recording process as disclosed by FIG. 9, including keystrokes (906) and full view recording (905), there is a possibility of confidential data sharing. To limit the visibility of data classified as confidential displayed on the screen of the first user (901), the invention discloses a system and method responsible for defining the information that shall not be further visible to the second user and further the conditioning of data access upon special permission set up. What is more, the permission system defines the storage access as disclosed by (909) conditions “confidential data”. In case of confidentiality (answer “YES”, 911) data can be accessed only by the user with predefined access (914). In case of no limit placed over data accessibility (answer “NO”, 912) the data stored in the local storage database (FIG. 9, 915) may be accessed by the second user (916) with no further pail fission requirements.

Redrawing of permitted texts starts with Optical Character Recognition of the raw image or video and analyzing the recognized text against suitable criteria for allowing parts of a text to be shown meeting the criteria to be shown to the second user of the invention (these predefined conditions may further be defined by a permission module). When the second user (801) requests via the second user processor (802) access (803) to a particular file stored in the local storage database, the request is processed by permission module (804). Upon fulfillment of the condition concerning limited access (805), the access is either granted (808) or refused (806). In case of positive requirement fulfillment, the content is displayed to the second user (809) and displayed on the second user processor. In case of a negative response, the action ends (810).

Such predefined setup programmed by the second user may include whitelisting of pre-defined words such as those which appear in user interface menus and other items. In this regard, whitelisting shall mean the list of allowed elements displayed to the second user after being recorded on the first user processor. Furthermore, the predefined setup programmed by the second user can be based on dictionaries which include words and syntax of certain language excluding e.g., proper nouns or any other words which might be mixed up with a name or other identifying information of a person.

Pre-defined words determine a whitelist for permitted words to be redrawn on the filtered video. An example of a list that indicates information to be displayed or not displayed shall include at least a couple of hundreds of words which are typical words and terms used on the user interface of a specific system to be monitored. The simplest realization of the invention is checking each recognized word from an image or video frame against the whitelisted words and if found there, the word will be drawn on the filtered picture or video at the same location where the matching word was originally detected. In addition to drawing the letters which form the word, a suitable colored background can be used for the text for making it readable on various backgrounds when the filtering has been applied. Permitted words can be tailored to a certain system also by composing whitelisted words by taking, words associated with the user interface from the source code or the terminology list of the system.

It is important to indicate the system and method steps are directed towards redrawing the content filtered out. The system compares the wording and other displayed content based on whitelists, blacklists, or other predefined conditions and then erases the visibility of the original content and redraws the content that is to be displayed to the second user. During erasing, the content is fully removed from the original recording and remains accessible only in the raw video material that is accessible upon predefined conditions. It is possible to both erase the content of the recorded application as well as the whole page context by detection of the targeted window by graphic features, window title, OCR-based detection, or any other pattern recognition.

To ensure the privacy of gathered data, video recordings are encrypted with PGP/GnuPG algorithm (2048 bit RSA+AES256). There is a dedicated public and private key pair for each customer managed by the permission module (FIG. 9, 909). The public key is also automatically set up on the first user processor. The private key is stored securely on the permission module. It can be also shared with the persons who are authorized to manually decrypt, view, and analyze the actual recordings based on the permission module settings.

Furthermore, clips recorded by the system may be synchronized continuously. The system enables clips throttling and whenever the local database storage is fully utilized the system triggers automatic clips removal starting from the oldest. The use of such storing management enables the local storage as well as optionally used cloud storage (1010) not to reach the memory quota. Regarding synchronization and data update, the present, invention uses HTTPS (1013) connections for synchronizing and uploading the recordings to the local data storage (1012) when the user is logged in through the application. The automatic application update procedure is part of the synchronization and can be replaced by managed updates by the customer's IT department. No other means of access is made possible during user experience monitoring to prevent any unauthorized access to the software or the user's device.

As screen recordings reveal any content viewed by the first user, the actual recordings may reveal sensitive, confidential, or secret information depending on the system under monitoring and what is more, may be strongly affected by data protection laws. Such an example remains of special importance for healthcare. Electronic Health Record systems are used to handle patient information constituting mostly confidential data.

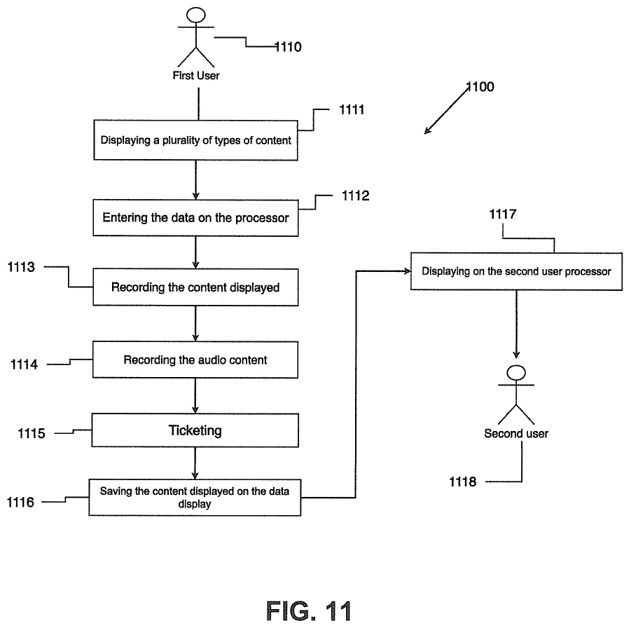

When it comes to the privacy of recorded clips, the second user of the invention may be a hospital IT department and the first user of the invention may indicate the clinician. When clips recorded on the processor of the clinician utilize pre-configurable full memory quota of the local storage (computer), the oldest clips may be removed thereby ensuring that the hospital IT department can always access up-to-date data of the clinician. Place of storage (by default local storage) may be exchanged for a cloud storage server. In the case of both local storage as well as cloud storage, the way of clips saving as well as database structure remains analogous. Consequently, the method steps begin with the first user action as disclosed by FIG. 11. The action of the first user is related to the as-is recording of display (1111) that may include entering the data on the processor (1113) by the first user and recording audio content by the first user (1114). Recorded content facilitates ticket reporting to the external ticketing system by the first user (1115), further saving the collected content (1116) along with displaying (1117) it on the second user processor.

Captured recordings are stored locally on a computer hard disk in default or user-specified location by the system settings. Video and optional audio are captured in mp4 format and the like as video clips usually with a length of 50 seconds and there are additional log files for capturing user inputs and user gathered events. Loop recording with short video clips ensures that a computer or software crash is not likely to cause data loss for more than the last 50 seconds of recording time (the worst-case scenario in case of the file corruption of ongoing video recording). No additional copies of any recordings are stored in the non-volatile memory of a user's processor

To define which user shall be assigned to a particular clip and which device was in use (the first user processor), the system collects a plurality of data about the user device and user ID. Assignment of clips to the user or plurality of users is defined by at least one of the following identifiers:
Logbook entries are maintained on a first user processor identifying the users based on their credentials and workstation-specific identification.
Every recording is automatically timestamped and provided with workstation identification which is unique for each desktop configuration.

The present invention further provides an option for viewing and analyzing the recordings while storing a log of each user while providing tracing granularity down to 50-second intervals (loop recording) of the captured video recordings. This construction of the present invention enables GDPR (General Data Protection Regulation) and HIPAA (Health Insurance Portability and Accountability Act) compliant traceability of information access and view logging when combined with the access log of the information system such as hospital information system. The interface reader is further configured to provide the required traceability as listed above. What is more, the present invention enables the possibility of access logging to comply with the security requirements under data protection laws generally, especially when it comes to accessing raw recordings including human-readable patient data by authorized users.

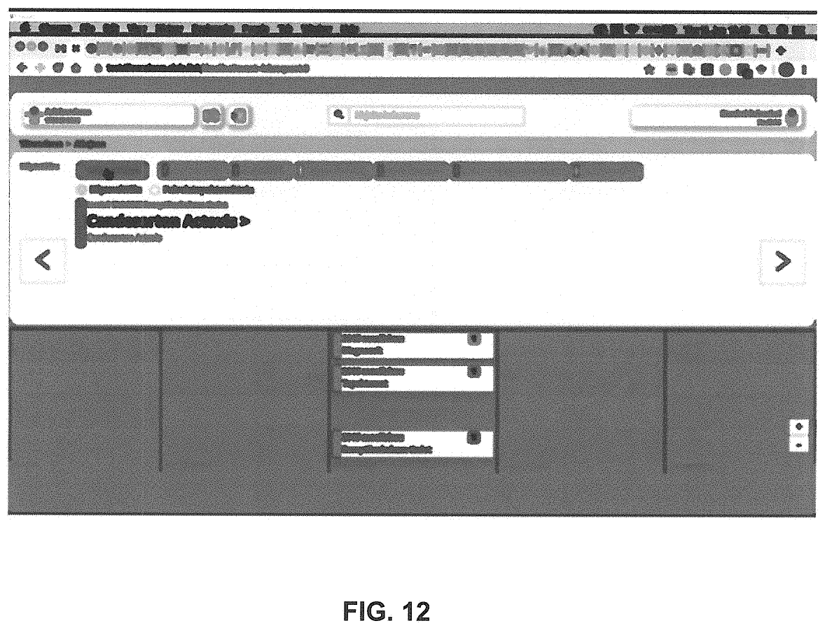

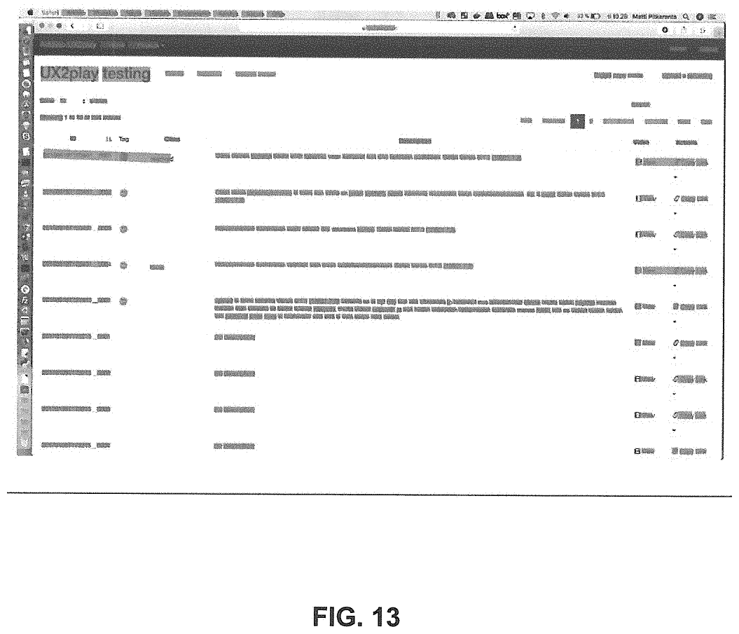

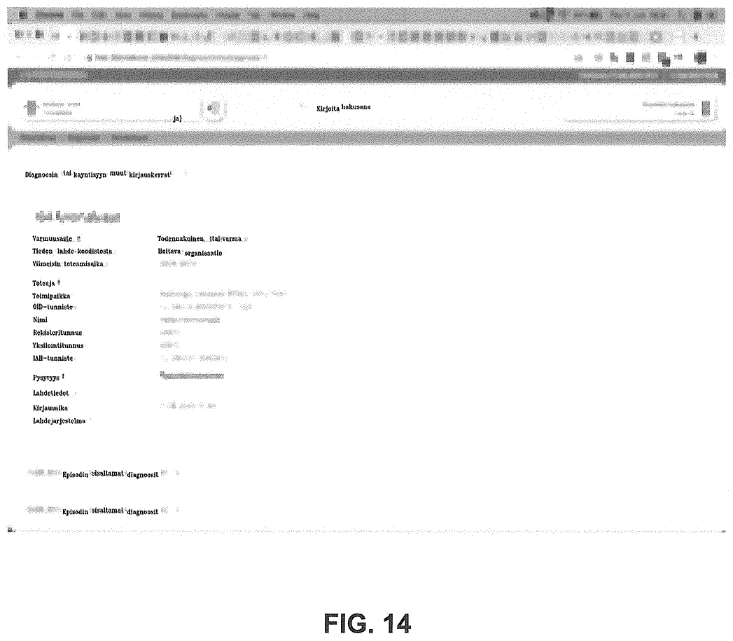

As a consequence, particular elements of the user interface may be qualified not to be displayed or to be erased in storage; the areas being firstly defined by the system and method that results in text or other content selection as disclosed in FIG. 13. As a consequence of such action, a screen recorded by the recording module is filtered in the areas classified as confidential (not allowed to be displayed) (FIG. 12). Consequently, the screenshot from a video recorded by the system shall indicate general elements displayed on the screen but with no detailed and/or readable content (FIG. 14), and elements filtered out are further replaced with the redrawn content.

As the opposite to predefined by the second user whitelisted words, the present method may also include application of blacklisted words, to be otherwise kept hidden as they might otherwise reveal too much information about an individual patient e.g. medicines or diagnoses in the medical context to exclude any patient-journal-entry related information and the like. Optical Character Recognition and video processing, in general, is a rather resource-consuming process, utilizing computer resources such as CPU, RAM, and memory drive.

The disclosed invention may accordingly be used in the following manner that ensures optimization:

1. the screen of the first user if recorded with the recording module of the disclosed invention running on a Macbook Pro computer of the first user;
2. video is processed with OpenCV library using parameters (Morphological Erosion, Disk Kernel=6, Iteration=1) which provides reasonable retraction of the smallest texts in the user interface view captured in video Processing and to be conducted by the recording module;
3. recognized navigation button texts and the numbers right after them are redrawn on the processed video. Text retraction can be also made with similar processing algorithms such as those which are used when converting pdf files into editable document or presentation formats.

To ensure that the permission module is not displaying the area classified as confidential (FIG. 12) in an efficient manner, such may be further supported by the machine learning algorithms that are configured to detect the area that is included on a blacklist, whitelist of otherwise specified as confidential by predefined conditions. Machine learning assistance requires feature extraction from the recorded first user-interaction data recorded on the first user processor. While the permission module operates along with the machine learning algorithm the comparison is done to look for similarities between display information restricted by the first user and second user predefined settings regarding confidential information and can be based on a mutual correlation between events or to find out clusters of events mapped in feature space described in the following sub-sections. Supervised learning is applied to existing event data to teach machine-learning-based clustering by providing groups of events to be classified as similar when observed by a person who is viewing the events and considering them to be evidently similar. This similarity can be a higher-level similarity associated with the same goal or task that the user has been doing, or some lower-level interaction pattern that might be belonging to different higher-level contexts but including similar problems or noteworthy observations on how the user interface is working (i.e., the taxonomy used with user interface elements or modality in the first user interface controls such as a drop-down field or user input validation). Incident duration is an event of sequential user interaction pattern which is required to precede the moment to the realization of a certain incident and to follow it either for recovering from it or for ending up in a situation where avoiding it or recovering from it is no longer manageable by the user.

In a repetitive manner, the recording module records clips of 50 seconds consecutively. In case of incidence occurrence, the recording module is configured to record additional clips that are triggered by the incident report (for example a ticket creation). In such circumstances, the recording module is further recording a plurality of clips prior to and following after the ticket creation based upon the first user ticket report.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A system for recording on-screen activity, maintaining the confidentiality of processed data and export to the external ticketing, the system comprising:
at least one first user processor configured to use a network connection in communication with a server;
a recording module configured to record on-screen display and content processed on the first user processor;
a content interpretation module configured to interpret the content displayed on the first user processor and arranged on the server;
a ticketing module configured to send the data to the external ticketing system and arranged on the server;
at least one second user processor comprising a service display, the at least one second user processor configured to display recorded content, tickets and logs collected by the recording module and ticketing module and arranged to use networked connection in communication with the server;
wherein, each of the first user processor, recording module, content interpretation module, and second user processor are configured to communicate via API arranged on the first user processor to exchange data between the first user processor and on-server elements.

2. The system according to claim 1, wherein the first user processor further comprises:
a data display configured to display a plurality of types of content including text, graphic elements, and audiovisual content;
a local database configured to save content displayed on the data display; the local database further comprising storage configured to save the content collected by the recording module; and
wherein the data display is further configured to display the content in a native resolution as well as scaled display configurations;
wherein first user data input is further configured to operate with a virtual keyboard, non-virtual keyboard and computer mouse; and
wherein, the data display, keyboard, and mouse capture are not configured to enable the injection of code, execute commands or exploit direct memory access on the first user processor.

3. The system according to claim 1, wherein the recording module further comprises:
an interface reader configured to record screen display via FFmpeg; and
wherein the interface reader is further configured to capture tapping into first user inputs with a keyboard and mouse for both virtual and non-virtual keyboard and computer mouse.

4. The system of claim 1, wherein the recording module further comprises:
an interface reader configured to record the content displayed on the first user processor and save it in the local storage database;
an audio reader configured to collect audio content;
a transcript module configured to continuously record clips of up to 50 seconds in duration;
a transcript module configured to record clips of a predefined time based on a creation of a ticket; and
a transcript module configured to timestamp recorded clips; and
wherein, the recording module is configured to use HTTPS to synchronize and upload recordings to the local database storage;
wherein, the recording module is further configured to suspend image data collection; and
wherein, the recording module is further configured to operate on user consent.

5. The system according to claim 1, wherein the recording module further comprises:
an interface reader configured to record clicked keys on the keyboard in the form of a timestamped event absent letter definition; and
the interface reader is further configured to collect other keystrokes at least of function keys and their combinations as is displayed on the display of the first user.

6. The system according to claim 1, wherein the recording module further comprises:
a transcript module configured to collect the information about the customer identification number; and
the transcript module is further configured to save in the local database storage the information about the customer identification number.

7. The system according to claim 1, wherein the recording module further comprises:
a transcript module configured to collect information about the unique first user processor number; and
the transcript module is further configured to save in the local database storage the information about the unique first user processor number.

8. The recording module of claim 1 is further configured to communicate with the content interpretation module over the network.

9. The system according to claim 1, wherein the recording module further comprises a ticketing module configured to:
collect the issue report triggered on the first user processor;
save the issue report into a local database;
send the issue report to the second processor; and
indicate an element on the interface to include in the ticket sent to the second processor.

10. The system according to claim 1, wherein the content interpretation module further comprises a permission module configured to allow access to the data saved in the local database storage, the system further comprising a permission module configured to:
store conditions that define areas to display on the second user processor;
store conditions that define areas to erase during saving in the local database storage;
store conditions that define areas to erase during saving in the cloud environment;
classify visible data as non-confidential;
send to save the data classified as confidential to the separate database tables;
display the data based on a predefined setup programmed by the second user;
save the data classified as confidential to the separate database tables based on a predefined setup programmed by the second user; and apply machine learning algorithm optimization to improve content detection accuracy.

11. The system of claim 1, wherein the second processor with service display further comprises:
a permission module settings configured to define conditions of what elements of the recorded content to display on the second user processor;
the permission module settings further configured to define conditions when to erase data display elements during saving in the local database;
display module configured to display data collected from the first user processor;
display module configured to display the data reported by the first user to the ticketing system;
at least one local database configured on the second user processor.
Wherein, saving in the local database may be exchanged with saving in the cloud environment.

12. The system of claim 2, wherein the first user processor further comprises:
the authorization module of the first user configured to identify during communication with the recording module by the customer identification number;
the authorization module of the first user configured to identify communication with the recording module with the unique second user processor number;

13. The system of claim 2, wherein the first user processor further comprises:
the local database storage is configured to save the content recorded by the recording module;
the local database storage is configured to save the timestamp for every clip recorded by the recording module;
the local database storage is configured independent maintenance of the entries in the database;
Wherein, each independent database entry includes one recorded clip.
Wherein, each independent database entry can be removed with no impact on the remaining local database storage entries.

14. The system of claim 2, wherein the local database further comprises:
non-confidential tables including, non-confidential data configured to be accessible with no additional limitations;
confidential tables including confidential data configured to be accessible only to the user with defined permission;
Wherein, the permission to access confidential tables is based on a predefined setup programmed by the second user.

15. The system of claim 2, wherein the second processor with service display further comprises:
display configured to present the non-confidential data accessible with no additional limitations;
display configured to present confidential data accessible only to the user with defined permission;
Wherein, the permission to access confidential data is based on a predefined setup programmed by the second user.

16. The system of claim 2, wherein the first user processor user further comprises:
the local database storage configured to communicate with the cloud storage;
the local database storage configured to send the data in the cloud storage;

17. The system of claim 10, wherein the content interpretation module further comprises:
permission module configured to store conditions that define areas to display during the saving in the cloud environment instead of the first user processor;
permission module configured to store conditions that define areas to erase during saving in the cloud environment instead of the first user processor;

18. The system of claim 10, wherein the content interpretation module further comprises:
the permission module configured to display the areas based on the selective classification of data;
the permission module configured to erase the areas based on the selective classification of data;
Wherein, the selective classification of data is based on a predefined setup programmed by the second user and is further configured to leave displayed the areas of input names and default fields that do not contain any customizable data.

19. A method for capturing user's on-screen activity allowing the confidentiality of the processed data to be maintained and ticketing, a method further comprising the steps of:
a plurality of types of content including text, graphic elements, and audiovisual content on the processor of the first user arranged in communication with a server;
entering the data on the first user processor via virtual and non-virtual keyboard or other user input;
recording the content displayed on the first user processor by the recording module arranged in communication with the server;
displaying a ticketing system on the recorded display arranged in communication with the first user processor;
saving the content displayed on the data display in the local database storage arranged on the first user processor;
synchronizing the content saved in the local database storage with the cloud storage;
accessing the content saved in the cloud storage database arranged in communication with the second user processor.
wherein, displaying the data includes displaying the content in a native resolution as well as scaled display configurations.
wherein, entering the data on the first user processor via virtual and non-virtual keyboards does not include injecting code, executing commands, or exploiting direct memory access on the first user processor.

20. The method of claim 19 further comprising the steps of:
recording screen display configured on the first user processor with the use of FFmpeg of similar technology;
recording tapping into first user inputs with the keyboard and mouse for both virtual and non-virtual keyboard and mouse.

21. The method of claim 19 further comprising the steps of:
recording the content displayed on the first user processor with the interface reader arranged in communication with the recording module;
saving in the local database clips that are up to 50 seconds in communication with recording module;
adding a timestamp for every recorded clips by the transcript module in communication with the recording module.
wherein, uploading the recordings and synchronization to the local database storage is configured via HTTPS;
wherein, uploading the recordings and synchronization to the local database storage is configured to suspend the collection of the image the data displays upon the first user's action.

22. The method of claim 19 further comprising the steps of:
recording press keys on the keyboard in the form of timestamped event with no letter definition arranged in communication with the recording module;
recording other keystrokes at least of function keys and their combinations as is displayed on the screen arranged in communication with the recording module.

23. The method of claim 19 further comprises the steps of:
recording the information about the customer identification number arranged in communication with the recording module;
saving in the local database stores the information about the customer identification number arranged in communication with the recording module;

24. The method of claim 19 further comprising the steps of:
recording the information about the unique first user processor number arranged in communication with the recording module;
saving in the local database storage the information about the unique first user processor number arranged in communication with the first user processor;

25. The method of claim 19 further comprises the steps of:
triggering the ticketing module on the first user processor arranged in communication with the ticketing module;
displaying the ticketing module on the display of the first user processor to collect the issue report entered by the first user arranged in communication with the ticketing module;
creating the ticket by the first user via the ticketing module displayed on the first user processor arranged in communication with the ticketing module;
saving the ticket created by the first user on the first user processor in the local database;
recording the clips prior to and following after the ticket creation arranged in communication with the recording module;
sending the ticket triggered on the first user processor to the second processor with service display.
wherein, displaying the ticketing system includes displaying the triggering option and data input on the first user processor.
wherein, saving the ticket includes information about the event clicked by the first user.

26. The method of claim 19 further comprising the steps of:
creating the ticket with a written description of the issue arranged in communication with the ticketing module;
creating the ticket with audio recording describing the issue arranged in communication with the ticketing module;

27. The method of claim 19 further comprising the steps of:
storing conditions that define areas to display during the display on the second user processor arranged in communication with the permission module;
storing conditions that define areas to erase during saving in the local database storage;
storing conditions that define areas to erase during saving in the cloud environment arranged on a server;
classifying displayed or erased data as confidential on the display configured on the first user processor;
sending the data classified as confidential to the separate database tables configured in the local database storage;
saving the data classified as confidential to the separate database tables configured in the local database storage;
wherein, at least one of erasing or displaying by the permission module is based on a predefined setup programmed by the second user.
wherein, saving the data classified as confidential in the separate database tables is based on a predefined setup programmed by the second user.

28. The method of claim 19 further comprising the steps of:
defining the conditions to display the data on the second user processor arranged in communication with the permission module;
defining the conditions to erase data display elements during saving in the local database arranged in communication with the permission module;
displaying the data collected from the first user processor in accordance with predefined conditions d arranged in communication with the permission module;
displaying the data reported by the first user to the ticketing system on the second user processor arranged in communication with the pet mission module;
wherein, saving in the local database may be exchanged with saving in the cloud environment.

29. The method of claim 19 further comprising the steps of:
including no limit to access the non-confidential tables that are configured to be accessible with no additional limitations arranged in communication with the permission module;
conditioning the access to the confidential tables that are configured to be accessible only to the user with defined permission arranged in communication with the permission module;

30. The method of claim 24 further comprising the steps of:
authorizing of the first user to be identified during communication with the recording module by the customer identification number;
authorizing of the first user to be identified during communication with the recording module by the unique first user processor number;

31. The method of claim 26 further comprising the steps of:
displaying the areas based on the selective classification of data according to the predefined setup programmed by the second user arranged in communication with the permission module;
erasing the areas based on the selective classification of data from the local database storage according to the predefined setup programmed by the second user arranged in communication with the permission module;
wherein the local database storage may be used interchangeably with cloud storage.
